(19) United States
(12) Patent Application Publication
(10) Pub. No.: US 2010/0289657 A1
(43) Pub. Date: Nov. 18, 2010

(54) SAFETY LINE ALARM APPARATUS AND METHOD

(76) Inventor: RENE OCASIO, West Hartford, CT (US)

Correspondence Address: ROBERT S. SMITH, 1131-0 TOLLAND TURNPIKE, SUITE 306, MANCHESTER, CT, 06042, US

(21) Appl. No.: 12/779,888

(22) Filed: May 13, 2010

Related U.S. Application Data
(60) Provisional application No. 61/177,778, filed on May 13, 2009.

(51) Int. Cl. G08B 21/02

(52) U.S. Cl. 340/644

(57) ABSTRACT

An alarm device for cooperation with an associated safety wire coupling a harness on a worker to an anchor point which includes a connector having first and second axial extremities fixed respectively to axially spaced points on the associated safety wire, the connector having a smaller axial extent than the axial extent of the axially spaced points on the associated safety wire, the connector including a switch having first and second portions having frictional engagement therebetween, the first and second portions being dimensioned and configured to disengage when the connector is taunt, and an alarm initiated when the first and second portions are separated. Some embodiments include an alarm device that includes an external alarm and signaling apparatus for communicating with the external alarm. The device may include both an internal alarm and a remote alarm. The apparatus may include an external alarm and radio frequency signaling apparatus for communicating with the external alarm.

### RELATED APPLICATIONS

This application is a continuation of Provisional US Application 61/177,778 filed May 13, 2009.

### FIELD OF THE INVENTION

The invention has particular application to methods and apparatus for improving safety and more particularly the safety of persons working at dangerous heights. The prior art includes a variety of personal fall protection apparatus. These include ascenders, descenders, lanyards, full body harnesses, rope grabs, vertical lifelines, temporary and permanent anchorages, lanyards and belts. Under normal working conditions, a worker, when working on a scaffold, catwalk or other locations that are at a relatively high place from where a fall could result in serious injury, will wear some type of safety harness. Typically, the safety harness is attached to a lanyard, which in turn is attached to an anchorage point. Various lanyards have been developed in order to provide the necessary resistance to decelerate a worker's fall. While such apparatus is useful for a variety of situations, persons working at significant heights are still exposed to significant risks.

### BACKGROUND OF THE INVENTION

Safety lines connecting a harness on workers to a secure structural element are widely used to secure such workers and prevent injuries and fatalities. While the use of such safety lines is enormously important to reducing worker injuries and fatalities, a weakness of such systems is that a worker may be located in an isolated area and/or the workplace environment may be very noisy. The noise may emanate from other workplace activities and/or urban/local ambient sources. Thus, a worker may fall, the safety line will stop the fall of the worker when the safety line is fully extended.

A person who falls who is protected by apparatus that stops the persons fall still is exposed or vulnerable to with orthostatic intolerance when suspended following a fall. Orthostatic intolerance may be defined as the development of symptoms such as light-headedness, palpitations, tremulous lists, poor concentration, fatigue, nausea, dizziness, headache, sweating, weakness and occasional fainting during upright standing. In the sedentary additions, blood can accumulate in the veins, which is commonly called “Venus pooling,” and cause orthostatic intolerance. Orthostatic intolerance can also occur when individual moves quickly after being sedentary for a long time.

A well known example of orthostatic intolerance is that of a soldier who faints while standing at attention for a long time period. The moment the soldier loses consciousness, he or she collapses into a horizontal position. With the legs heart and brain on the same level, blood is returned to the heart. Assuming no injuries are caused during the collapse, the individual will quickly regained consciousness and recovery is likely to be rapid.

Venus pooling typically occurs and the legs due to the force of gravity and a lack of movement. Some Venus pooling occurs naturally when a person is standing. In the veins, blood normally is moved back to the heart through one-way valves using the normal muscular action associated with limb movement. If the legs are immobile, these “muscle pumps” do not operate effectively, and blood can accumulate. Since veins can expand, a large volume of blood may accumulate in the veins.

An accumulation of blood in the legs reduces the amount of blood in circulation. The body reacts to this reduction by speeding up the heart rate in an attempt to maintain sufficient blood flow to maintain sufficient blood flow to the brain. If the blood supply is significantly reduced, this reaction will not be effective. The body will abruptly slow the heart rate and blood pressure will diminish in the arteries. During severe Venus pooling, the reduction in quantity and/or quality (oxygen content) and a blood flowing to the brain causes fainting this reduction can also have a fact and other vital organs such as the kidneys. The kidneys are very sensitive to blood oxygen, and renal failure can occur with excessive Venus pooling if these conditions continue, they potentially may be fatal.

Orthostatic and tolerance may be experienced by workers using fall are rest systems. Following a fall a worker may remain suspended in a harness. The sustained in mobility may lead to a state of unconsciousness. Depending on the length of time the suspended worker is unconscious/immobile and the level of Venus pooling, the resulting orthostatic intolerance may lead to death. Such fatalities often are referred to as “harness-induced pathology” or “suspension trauma.” Others categorize deaths that occur after upright suspension in a harness as rescue deaths as the result of suspension syndrome, suspension trauma syndrome, orthostatic hypotension and reflow syndrome. Research now shows that patients suspended in a motionless position, such as in vertical rescues, are at a high risk of rapid death. Sometimes death may occur within just a few minutes.

Unconscious/immobile workers suspended in their harness will not be able to move their legs and will not fall into a horizontal position, as they would if they faded while standing. During the static upright position, venous pooling is likely occur and cause orthostatic intolerance, especially if the suspended worker is left in place for some time. Venus pooling and orthostatic intolerance can be exacerbated by other circumstances related to the fall. For example, shock or the experience of the event that caused the full, other injuries, the fit/positioning of the harness, the environmental conditions, and the workers psychological state all may increase the onset and severity of the pooling and orthostatic intolerance. And lest the worker is rescued promptly using established safe procedures, Venus pooling and orthostatic intolerance could result in a serious or fatal injury, as the brain, kidneys, and other organs are deprived of oxygen.

The amount of time spent in this position, with the legs below the heart, affects the manner in which the workers should be rescued. Moving the worker quickly into a horizontal position, a natural reaction, is likely to call as a large volume of deoxygenated blood to move to the heart, if the worker has been suspended for an extended period. The heart may be unable to cope with the abrupt increase in blood flow, causing cardiac arrest. Rescue procedures must take this into account.

The U.S. Department of Labor, Occupational Safety & Health Administration has accordingly made recommendations with regard to prolonged suspension from full arrest systems that include rescuing suspended workers as quickly as possible. Because of the work place ambient noise or the isolation of the worker others may not recognize then a fall has occurred. Suspension that continues any more than 10 minutes increases rapidly the risk of irreparable damage. The worker who has fallen may not be able to scream loudly or long enough to alert others that a fall has occurred and the worker being suspended by the safety line. Extended periods of suspension in this manner may in some cases result in compression of the artery of the worker extending through the workers upper leg. This compression may have serious physical consequences and can be fatal.

### SUMMARY OF THE INVENTION

It is an object of the present invention to increase the safety of workers who must work at great heights.

It is another object the present invention to provide apparatus that signals when such a worker has fallen.

It has now been found that these and the other objects of the present invention may be achieved in an alarm device for cooperation with an associated safety wire coupling a harness on a worker to an anchor point which includes a connector having first and second axial extremities fixed respectively to axially spaced points on the associated safety wire, the connector having a smaller axial extent than the axial extent of the axially spaced points on the associated safety wire, the connector including a switch having first and second portions having frictional engagement therebetween, the first and second portions being dimensioned and configured to disengage when the connector is taunt, and an alarm initiated when the first and second portions are separated.

Some embodiments include an alarm device that includes an external alarm and signaling apparatus for communicating with the external alarm. The device may include both an internal alarm and a remote alarm. The apparatus may include an external alarm and radio frequency signaling apparatus for communicating with the external alarm.

The invention also includes the method for initiating an alarm when a worker falls which includes providing a safety wire coupling a harness on a worker to an anchor point; providing a connector having first and second axial extremities fixed respectively to axially spaced points on the safety wire having a smaller axial extent than the axial extent of the axially spaced points on the safety wire; and providing a switch as part of the connector having first and second portions having frictional engagement therebetween, that are dimensioned and configured to disengage when the connector is taunt, and

initiating an alarm when the first and second portions are separated.

The method may include providing an external alarm and signaling apparatus for communicating with the external alarm. Some forms of the method may include providing both an internal alarm and a remote alarm. The method may include providing an external alarm and radio frequency signaling apparatus for communicating with the external alarm.

### BRIEF DESCRIPTION OF THE DRAWING

The invention will be better understood by reference to the accompanying drawing in which:

FIG. 1 is a partially schematic of a preferred embodiment of the present invention.

FIG. 2 is a block diagram illustrating in greater detail portions of the apparatus illustrated in FIG. 1.

### DESCRIPTION OF THE PREFERRED EMBODIMENTS

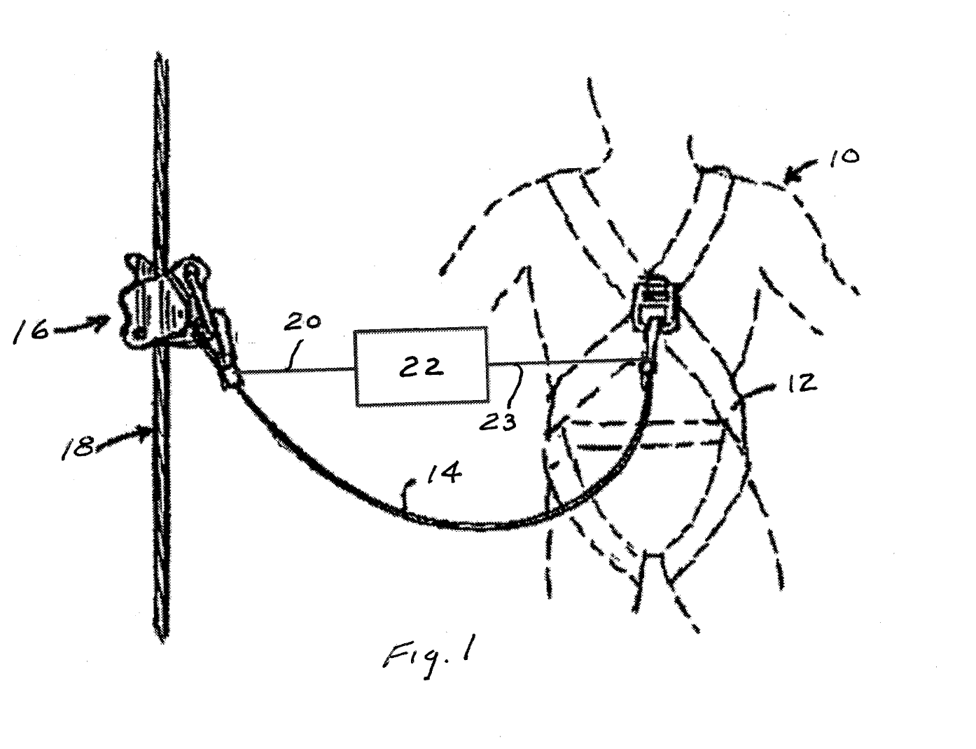

Referring now to FIG. 1, there is shown a worker 10 having a safety harness attached to the torso of the worker. In the conventional manner, a safety wire or lanyard 14 is secured to the safety harness to 12 as well as to a secure anchor point is achieved by a safety anchor 20 attached to a vertical cable 18. The vertical cable may be an elevator cable. In various embodiments the secure anchor point may be achieved with ring shaped extremity (not shown) on the safety wire 14. The ring shape extremity slides a generally horizontal cable (not shown). Such embodiments are best suited to protect workers that must move back and forth at substantially the same elevation while completing a given task. A representative fall arrest mechanism is shown in U.S. Pat. No. 6,533,066 issued Mar. 18, 2003 to David Ray O'Dell.

Other known safety harness constructions include the device illustrated in U.S. Pat. No. 4,618,026 which shows a shock absorbing lanyard having overlaying or superposed sections of webbing which are stitched together and are pulled over a separating means by a force applied thereto during a fall so that successive portions of the superposed sections are separated. Thus, a counteracting shock absorbing force limits the violence of a fall.

Another type of shock absorbing lanyard is illustrated in U.S. Pat. No. 4,253,544 wherein a tensile load bearing woven core is surrounded by a jacket. The jacket is longer than the woven core and the excess material is bunched or gathered accordion style at one end of the lanyard. An indicator flag is affixed to the gathered section and is released when a suitable load causes the gathered section to stretch.

The present invention adds an alarm device 22 connected by respective cables 20, 23 to the axial extremities of the safety line 14. The combined axial extent of the cables 20, 23 and the alarm device 22 must be less than the axial extent of the safety line 14. More specifically, this dimensional relationship must exist after a fall has occurred. Because the safety line 14 may include overlaid axial parts stitched together that will become unstitched when the worker fall, the length of the safety line may substantially increase upon the occurrence of a fall.

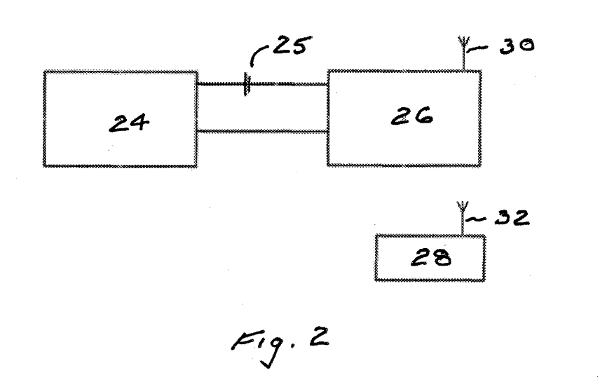

Referring now to FIG. 2, the alarm device 22 includes a lanyard alarm such as the Bosch Series SE2X-304. Further information about such commercially available devices appear at: http://resource.boschsecuritv.com/documents/SE2SeriesPerson_InstallationGuide_SE2_enUS_T3757581067.pdf. With the Lanyard Alarm feature enabled (the pin is pulled out), the transmitter sends an alarm signal to a central console that activates Auto Tracking. Less sophisticated forms of the invention may include the alarm function within the same housing as the housing into which the pin is engaged before activates. Similar devices used in retail store theft prevention applications are described at http://www.securemesolutions.com/58KHz_AM_Retail-Alpha S3_Alarm_Secured_CableLok_{—}48_Lanyard.html

Thus, a connector or jack 24 somewhat similar to that commonly used for mini-plugs and phono plugs. Conventional panel-mounting jacks are often provided with switch contacts. Most commonly, a mono jack is provided with a single normally closed (NC) contact, which is connected to the tip (live) connection when no plug is in the socket, and disconnected when a plug is inserted. In the same general manner in a preferred embodiment of the present invention the withdrawal of the cable 20 from the alarm device 22 withdraw as the table 20 from the connector 24 permitting the closure of contacts within the connector 24. It will be understood that the cable 20 is not conducting electric current. More specifically, the cable 20 withdraws a pin that causes two electric contacts to close and initiate an alarm. In other words, the connector may be merely two normally close electrical contacts that are separated by a non-conductive removable pin on the axial extremity of the cable 20 in one embodiment of the present invention.

The closure of the contacts within the connector 24 completes a circuit between a battery 25 and an annunciator 26. In the event the worker 10 falls the cable 20 will withdraw from the connector 24 that is part of the alarm device 22. Because the length of the combination of the cables 20, 23 and the device 22 is less than the safety cable 14, the cable 20 will withdraw from the connector 24 before the safety wire 14 is taut and supporting the worker 10. Accordingly, an audible alarm is produced by the annunciator 26 to alert other personnel of the plight of the worker 10.

The embodiment described above utilizes an audible signal to alert other personnel. In other embodiments a remote device 28 may produce audible and/or visual alarms. The remote alarms may be triggered by radio frequency signals transmitted respectively by antennas 30, 32. Other embodiments of the present invention may utilize infrared or other wired or wireless means for transmitting an alarm.

The schematic representation in FIG. 2 diagrammatically represents the cables 20, 23 and device 22 extending between the extremities of the safety line 14. It will be understood by those skilled in the art that a typical cable 14 will have overlaying or superposed sections of webbing which are stitched together and are pulled over a separating means by a force applied thereto during a fall so that successive portions of the superposed sections are separated to thereby generate a counteracting force to a fall as described in U.S. Pat. No. 4,618,026. As described in U.S. Pat. No. 4,253,544 may be surrounded by a jacket. In a preferred embodiment of the present invention the combination of the cable 20, device 22 and cable 23 while having a combined length that is less than the length of the cable 14 after a fall has occurred. It will be understood that the effective length of the cable 14 will increase in reaction to the axial forces thereon imposed by a falling worker. For example, the separation of the overlaying sections of webbing that are stitched together as a result of a fall will increase the effective length of the cable 14. Thus, the ultimate length of the combination of the cable 20, device 22 and cable 23 will be less than the ultimate length of the cable 14 and therefore the device 22 will be activated in the event of a fall. A sleeve may surround an axial portion of the cable 20, device 22 and cable 23 assembly as well as the cable 14. The sleeve will ordinarily be sufficiently sturdy enough to prevent snagging and fragile enough to break away in the event of a fall.

Although, the description above refers to an embodiment in which two contacts close when a pin is withdrawn, it will be understood that other embodiments will initiate an alarm if two contacts are separated by movement of a pin. Some embodiments may use a lanyard or safety cable that is a stainless steel aircraft cable type 7×19 (¼″) having a 6400 lb. tensile strength. The battery may be an Ultralife 9 volt 10 year battery having an Underwriters Laboratory approval. The connector 24, battery 25, and annunciator 26 may be epoxy potted together. A strobe light may be used in place of or in combination with the annunciator 26.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference. Although the specification and claims may refer to protecting a “worker” because that is a major application of the present invention, it will be understood that the term is intended to include others including but not limited to participants in recreational activities such as rock climbers. Furthermore, the schematic representation of the drawing illustrates a cable 20, device 22 and cable 23 assembly having the axial extremities thereof joined essentially to the axial extremities of the cable 14. Some embodiments may have the equivalent of the cable 20, device 22 and cable 23 assembly joined to only a relatively short part of cable 14. Since the entire axial extent of cable 14 will be in tension when I fall occurs, it is only necessary that (1) the length of the cable 20, device 22 and cable 23 assembly be less than (2) the length of the axial portion of the cable 14 (after the fall) to which it is attached. Remote alarms may include alarms at a management or control point such as a construction site trailer or other temporary building to ensure recognition of the emergency by other personnel.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C.112, sixth paragraph, unless the element is expressly recited using the phrase “means for.”

What is claimed is:

1. An alarm device for cooperation with an associated safety wire coupling a harness on a worker to an anchor point which comprises:
a connector having first and second axial extremities fixed respectively to axially spaced points on the associated safety wire, said connector having a smaller axial extent than the axial extent of said axially spaced points on the associated safety wire, said connector including a switch having first and second portions having frictional engagement therebetween, said first and second portions being dimensioned and configured to disengage when said connector is taunt, and
an alarm initiated when said first and second portions are separated.

2. An alarm device as described in claim 1 wherein said device includes an external alarm and signaling apparatus for communicating with said external alarm.

3. An alarm device as described in claim 1 wherein said device includes both an internal alarm and a remote alarm.

4. An alarm device as described in claim 1 wherein said device includes an external alarm and radio frequency signaling apparatus for communicating with said external alarm.

5. A method for initiating an alarm when a worker falls which comprises:
providing a safety wire coupling a harness on a worker to an anchor point;
providing a connector having first and second axial extremities fixed respectively to axially spaced points on the safety wire having a smaller axial extent than the axial extent of said axially spaced points on the safety wire;
providing a switch as part of said connector having first and second portions having frictional engagement therebetween, that are dimensioned and configured to disengage when said connector is taunt, and
initiating an alarm when said first and second portions are separated.

6. The method as described in claim 5 that includes providing an external alarm and signaling apparatus for communicating with the external alarm.

7. The method as described in claim 5 that includes providing both an internal alarm and a remote alarm.

8. The method as described in claim 5 that includes providing an external alarm and radio frequency signaling apparatus for communicating with the external alarm.
